(19) United States
(12) Patent Application Publication
(10) Pub. No.: US 2021/0349970 A1
(43) Pub. Date: Nov. 11, 2021

(54) APPLICATION PROTECTION ENFORCEMENT IN THE CLOUD

(71) Applicant: ARRIS Enterprises LLC, Suwanee, GA (US)

(72) Inventors: Rafie Shamsaasef, San Diego, CA (US); Lex A. Anderson, Auckland (NZ); Alexander Medvinsky, San Diego, CA (US)

(73) Assignee: ARRIS Enterprises LLC, Suwanee, GA (US)

(21) Appl. No.: 17/308,865

(22) Filed: May 5, 2021

Related U.S. Application Data
(60) Provisional application No. 63/021,281, filed on May 7, 2020.

(51) Int. Cl. G06F 21/10; H04L 29/06

(52) U.S. Cl. CPC G06F 21/10; G06F 2221/2101; H04L 63/0823; H04L 63/20

(57) ABSTRACT

A method and system provide the ability to enforce application protection in the cloud. A request to register an application is received in a registration tool executing within a cloud computing environment. The registration tool collects application information data and protection policy settings, and registers the application by returning, to a build-time environment, a secure protection authorization (SPA) certificate that authorizes the application to be built. A build registration tool executing in the cloud computing environment receives, from a cloud protection toolchain executing in the build-time environment, signed build-data that includes the SPA and build information for a build of the application. After determining, in the cloud, that the SPA is authenticate, developer credentials are authorized, and the build information is valid, the build registration tool responds to the cloud protection toolchain that the build for the application is authorized.

### BACKGROUND

### 1. Field

The present disclosure relates to systems and methods for ensuring the security of applications, and in particular to a system and method for protecting and enforcing the security of applications in the cloud.

### 2. Description of the Related Art

Prior art software applications are protected with various mechanisms by protection tools that read security parameters from source code or from external inputs during the build process. FIG. 1 illustrates an exemplary application protection scheme of the prior art. As illustrated, inputs include source code 102, security parameters in the source code 104, and external security parameters 106. The protection tools 108 receive/process the input 102-106 to protect the source code 102. The protection tools 108 include various modules/capabilities including control and data flow obfuscation 110, dynamic tamper protection 112, anti-debug protection 114, and security auditing capability 116. The parameters 104 and 106 provide the ability to tune/define a protection schema/the various tools 110-116 for each portion of source code 102 (e.g., one or more specific modules, the entire code base, etc.). For example, the parameters 104-106 may tune control and data flow obfuscation tool 110 to provide that 50% of the data in source code 102 is obfuscated. Similarly, parameters 104-106 may tune anti-debug protection tool 114 such that certain modules only have 20% anti-debug protection. These tools 108 output protected binaries 118, dynamic code signing certificates 120, and audit data 122. In this regard, as protection tools 108 include dynamic tamper protection 112, the protection tools 108 may have code signing capabilities thereby resulting in the dynamic code signing certificates 120 that may be used for verification/authentication by a recipient. In addition, the security auditing tool 116 enables the output of audit data 122 (e.g., in an audit report) that may identify the security coverage of the various forms of protection (e.g., how much protection for each module of source code 102 has been performed/enabled).

While the application protection scheme of the prior art may be useful, the scheme comes with a unique set of problems. For example, the protection process is typically controlled by a development team, which may not have specialized knowledge of application security (i.e., the development teams has their own expertise that may not be focused on application security). There is also no guarantee that adequate application protection is defined for an application due to insufficient or undefined protection policies and automated enforcement thereof. In addition, security audit data 122 may not be accessible or may not be in the right format to be useful to managers or security experts wishing to carry out a security review.

Further to the above, it may be noted that the protection process is iterative during the build process (e.g., initial builds may be protected using one set of parameters 102-106 and later run-time builds may require/necessitate different parameters 102-106 to ensure sufficient security). However, builds that pass an initial security review may introduce security issues in later builds. Such security lapses may go unnoticed by the relevant parties due to a lack of feedback during the build process (i.e., a build-process feedback loop is missing from the prior art). Additionally, ongoing security issues may go unnoticed due to a lack of feedback from the runtime environment (i.e., a runtime feedback loop is missing from the prior art).

In view of the above, the prior art software application protection schemes fail to address many problems and lack the desired level of security throughout a product's development lifecycle (e.g., from build to runtime).

### SUMMARY OF THE INVENTION

To overcome the problems of the prior art, embodiments of the invention introduce a new cloud-based application protection enforcement service that is controlled and monitored by those with relevant management and security expertise. Predefined application protection policies are enforced by the cloud system.

A cloud service collects security data at build-time and runtime (i.e., to facilitate monitoring and controlling). In this regard, raw audit data is sent to the cloud service at build-time. Further, real-time security data may be collected via instrumented binaries to track runtime security issues.

Detailed security audit reports can identify the security coverage of all protection mechanisms as well as runtime metrics. For example, the audit report may reflect that security may have been imposed on a special area/library/application programming interface (API)/software development kit (SDK) of the application (e.g., instead of the entire application). In addition, actual data may be displayed alongside the relevant policies, highlighting all non-compliances at build-time and runtime.

Security issues and variances from defined policies may trigger various actions. For example, non-compliant builds can be prevented from completing until they have been reconfigured or reviewed. In this regard, when an application has not met a certain threshold (e.g., with respect to security), the application may be non-compliant and the system will prevent completion of the build. Based on such non-compliance, alert notifications can be sent to authorized interested parties indicating the requirement for review or highlighting detected security issues.

### BRIEF DESCRIPTION OF THE DRAWINGS

Referring now to the drawings in which like reference numbers represent corresponding parts throughout:

FIG. 1 illustrates an exemplary application protection scheme of the prior art;

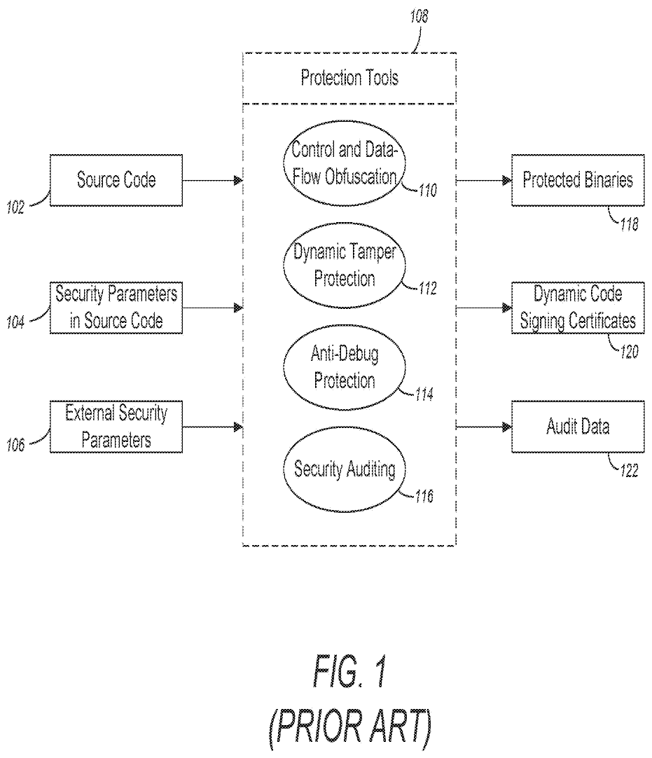

FIG. 2 illustrates the workflow for enforcing application protection in the cloud in accordance with one or more embodiments of the invention;

FIG. 3 illustrates the workflow for enforcing application protection in the cloud with runtime metrics in accordance with one or more embodiments of the invention;

FIG. 4 illustrates the general logical flow for enforcing application protection in the cloud in accordance with one or more embodiments of the invention

FIG. 5 is an exemplary hardware and software environment used to implement one or more embodiments of the invention; and

FIG. 6 is an exemplary hardware and software environment used to implement one or more embodiments of the invention.

### DETAILED DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Application Protection Enforcement in the Cloud

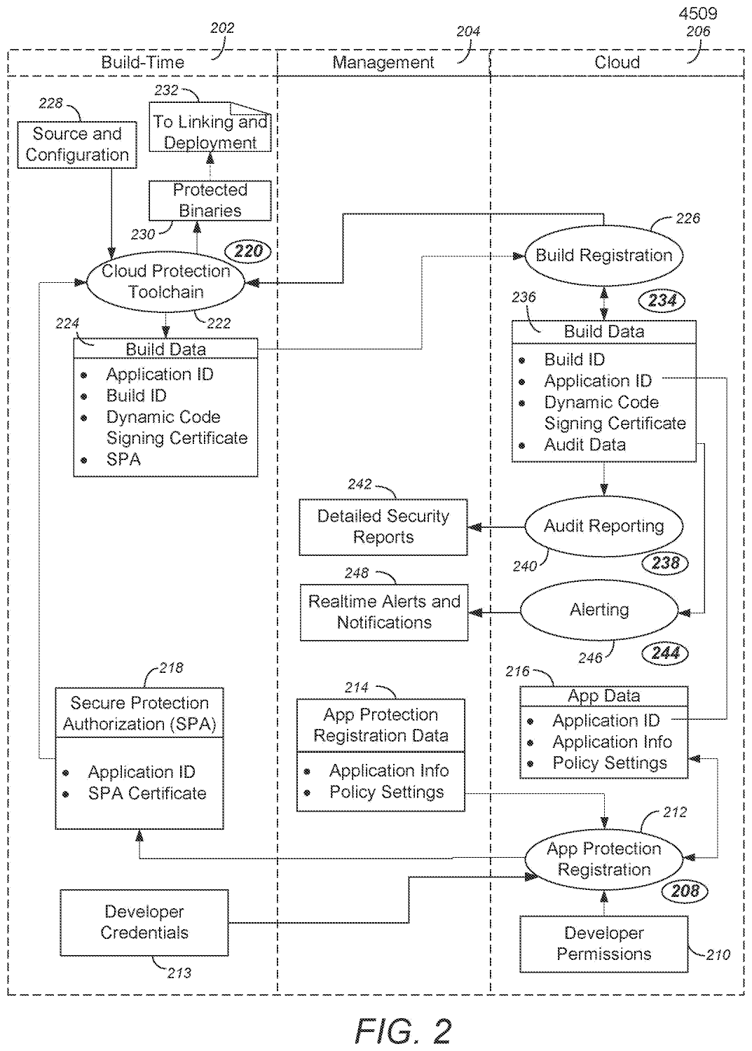

FIG. 2 illustrates the workflow for enforcing application protection in the cloud in accordance with one or more embodiments of the invention.

The different columns represent the different stages/locations where actions are performed. Build-time 202 includes those processes and components accessed/used during build-time. Similarly, management 204 (e.g. the development team manager or product security oversight manager) performs the steps may have access to the components in the management 204 column, and the cloud 206 column includes those actions performed in the cloud and components that are maintained in/on the cloud.

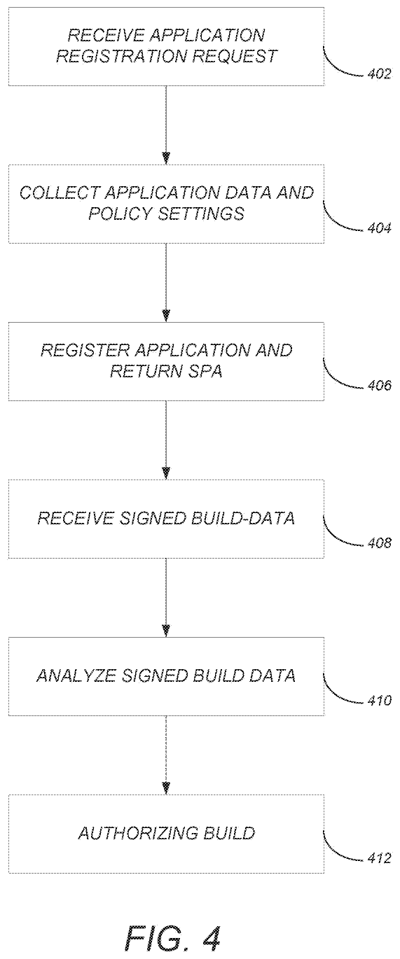

At step 208, in the cloud, the developer permissions 210 (e.g., to submit requests to register an application) are provided to an application protection registration tool 212 (e.g., by a cloud administrator). For example, a manager may log into a cloud service 206 (with a separate set of manager credentials) and provide application security policy information (e.g., as part of application data 216 and/or application protection registration data 214). Further, in one or more embodiments, during build-time 202 a developer may log-in and provide developer credentials 213 (e.g., while submitting an application registration request [see step 402 of FIG. 4 below]).

The application protection registration tool 212 receives the application protection registration data 214 (e.g., application information and protection policy settings) from management 204. The application protection registration tool 212 is responsible for registering the application and protection policy settings within the cloud as well as authenticating developers access (e.g., the application protection registration tool 212 compares the developer permissions 210 to the developer credentials 213 to authenticate the developer and confirm the developer has appropriate permissions to submit the application registration request). Accordingly the application protection registration tool 212 supplies the application data 216 (e.g., the application details such as the application identification [ID] and application information, and protection policy settings) for the application to the cloud 206 endpoint. The policy settings (also referred to as protection policies and/or protection policy settings) may list the protection modules (i.e., the modules to be protected) along with parameters, such as minimum required coverage per module.

Registration step 208 may be done entirely via a web interface to the cloud 206 service. During the registration 208, the registration will fail if the developer credentials are not authorized by the cloud service. A successful registration returns Secure Protection Authorization (SPA) data 218 including an SPA certificate that authorizes an application (e.g., based on the application ID within the SPA data 218) to be built according to the submitted policies (e.g., the policies within app data 214). Of note is that the certificates may also contain elements such as sequence numbers, nonces, and expiry dates as dictated by implementation requirements. As used herein, a nonce may be an arbitrary number that can be used just once in a cryptographic communication; a nonce is often a random or pseudo-random number issued in an authentication protocol to ensure that old communications cannot be reused in replay attacks. Accordingly, as depicted in FIG. 2, the development team desires authorization to secure the application/source code 228 and goes through the cloud 206 (i.e., application protection registration tool 212) to receive the appropriate permissions (i.e., to receive the SPA 218).

At step 220, the cloud protection toolchain 222 reads the SPA data 218 (at build time 202), and incorporates the SPA 218 into a signed build-data bundle 224 (e.g., that includes the application ID, build ID, dynamic code signing certificate and SPA) that is sent to the build-registration cloud endpoint 226. In this regard, the cloud protection toolchain 222 is used to register the application to be protected and define the policy for it. More specifically, the cloud protection toolchain 222 receives the source code and configuration information 228, and protects the source code using the tool chain resulting in protected binaries 230 that may be used downstream for linking and deployment 232. As depicted in FIG. 2, the toolchain 220 generates the build ID 224 while generating the protected binaries 230.

In view of the above, the SPA 218 is received (by the developer during build-time 202) as part of a build authorization request from the developers sent to the application protection registration tool 212 in the cloud 206. The SPA 218 includes the application information/data 216 including policy settings (e.g., the policies for the security settings build/level) and is signed by the cloud service 206. Once the appropriate authorization is received from application protection registration tool 212 (i.e., via SPA 218), and the protected binaries 230 are generated, the cloud protection toolchain 222 furnishes the build data 224 to the build registration tool 226 to register the application. As described above, the build data 224 includes all of the credentials (i.e., the developer credentials in the form of SPA 218) needed to authenticate the build as well as the signed policy information (i.e., the dynamic code signing certificate).

At step 234, the build registration tool 226 takes the build data 224, verifies it, and creates a new build data set 236 that includes the audit data (e.g., an audit report). The cloud service 206 will only authorize a build (i.e., via build registration 226) if the following conditions are met:
The SPA 218 is authentic, developer credentials/permissions are authorized, and the build data is valid 224.
The audit data complies with the protection policies defined for the application.

At step 238, the audit reporting tool 240 provides the detailed security reports 242 to the management 204. In this regard, the detailed security reports 242 are tailored to management 204. Further, non-compliant builds (as determined by the build registration tool 226) identify variances from protection policies which are specified in the detailed security reports 242. For example, a policy may require 50% obfuscation coverage and the build may only have 20%. In this regard, the detailed security reports 242 (also referred to as audit reports) shows conformance (or non-conformance) to protection policies.

At step 244, the alerting tool 246 provides real-time alerts and notifications 248 to management. Such real-time alerts/notifications 248 are sent according to application protection policies (e.g., provided in the application data 216 that is linked by application ID in the build data 236). In one or more embodiments, the alerting tool 246 sends alerts based on various thresholds. Further, in one or more embodiments, steps 238 and 244 may be performed simultaneously by/in the cloud service 206.

Application Protection Enforcement with Runtime Metrics

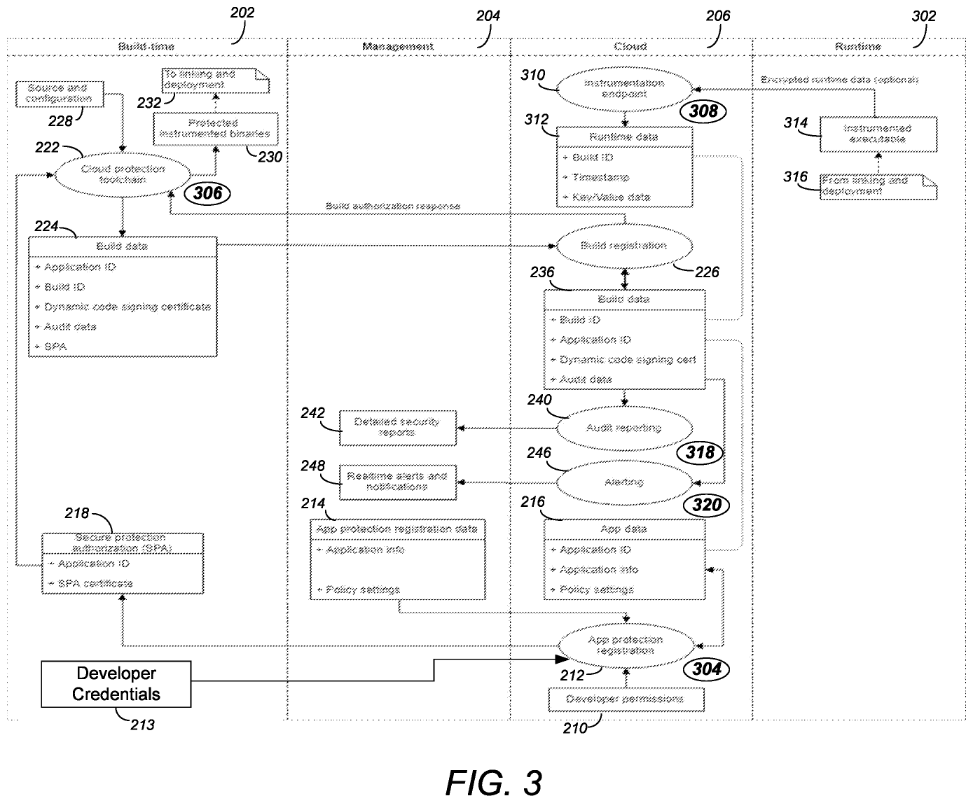

FIG. 3 illustrates the workflow for enforcing application protection in the cloud with runtime metrics in accordance with one or more embodiments of the invention.

The processes illustrated in FIG. 3 is similar to that of FIG. 2 but for a few key differences including various runtime 302 processes. In step 304, in addition to the actions performed in step 208 of FIG. 2, the application protection registration tool 212 may also define additional policies to track specific runtime metrics. For example, a policy (e.g., from within application data 216) may be set to track the number of detected tampering attacks within a specific time period. Further, thresholds can be set for acceptable ranges for each metric, which can trigger alert notifications if the thresholds are exceeded. For example a new minimum acceptable obfuscation range (or percentage) is set based on the data from previous protection audit reports. These thresholds are in the discretion of Management 204 and are typically based on historical data or observations.

At step 306, in addition to the actions performed in step 220 of FIG. 2, the cloud protection toolchain 222 embeds runtime instrumentation into the protected binaries 230 according to the policy settings for the application.

At step 308, an instrumentation cloud endpoint 310 securely gathers runtime metrics 312 from the instrumented executables 314 (e.g., acquired from linking and deployment 316 and executed in a runtime environment 302). The runtime metrics 312 is organized by build ID, timestamp, and key-value data/type format. The instrumentation endpoint 310 may run the instrumented executables 314 against obfuscation or other data to determine the runtime data/metrics 312 which may include data on tampering attempts, debugging attempts, dynamic code signing failures, and custom runtime events, such as authentication failures, authorization failures and crashes.

At step 318 (in addition to the actions performed at step 238 of FIG. 2), the audit reporting tool may provide detailed security reports 242 that tracks runtime metrics and identifies variances from the defined policies. In other words, step 318 provides the detailed security reports 242 to management 204. Accordingly, via the audit reporting tool 240, the runtime data 312 (e.g., linked by build ID to the build data) may provide runtime feedback to management 204 and security experts (e.g., during build time 202). Further, the runtime data 312 may be formatted for management or other data security expert as needed/desired. This data 312 eventually helps to adjust the protection policy applicable for the application.

At step 320 (in addition to the actions performed at step 244 of FIG. 2), alerting tool 246 may provide real-time alerts and notifications 214 that may be triggered based on runtime metrics exceeding predefined thresholds as defined in the application protection policies.

### General Logical Flow

FIG. 4 illustrates the general logical flow for enforcing application protection in the cloud in accordance with one or more embodiments of the invention.

At step 402, an application protection registration tool, executing within a cloud computing environment, receives a request to register a first application for protection. Such a request may be received via a web interface to the application protection registration tool

At step 404, application information data and protection policy settings for the first application are collecting in the application protection registration tool.

At step 406, the first application is registered, via the application protection registration tool, by returning, to a build-time environment, a secure protection authorization (SPA) certificate that authorizes the first application to be built according to the collected protection policy settings. The SPA includes first developer credentials.

At step 408, signed build-data is received in a build registration tool executing in the cloud computing environment (from a cloud protection toolchain executing in the build-time environment). The signed build data includes the SPA and build information for a build of the first application.

At step 410, the signed build data is analyzed by determining, in the cloud computing environment, that the SPA is authenticate, the first developer credentials are authorized, and the build information is valid.

At step 412, based on the determining, the build registration tool responds to the cloud protection toolchain that the build for the first application is authorized. Step 412 may further include the build registration tool generating audit data for the build and determining that the first application is authorized based on compliance of the audit data with the collected protection policy settings. Further, step 412 may include an audit reporting tool, executing in the cloud computing environment, generating a security report based on the audit data (where the security report identifies variances from the collected protection policy settings). In addition, step 412 may include an alerting tool, executing in the cloud computing environment, generating a real-time alert in accordance with the collected protection policy settings.

As part of the protection enforcement, step 404 may include collecting, in the application protection registration tool, second developer credentials, step 410 that are determined (by the application protection registration tool in step 410) to be inconsistent with the developer permissions and are therefore not authorized. As a result of determination of unauthorized credentials, the process does not proceed to step 412 and instead, the registration of the first application fails.

As described above, embodiments of the invention may also utilize runtime metrics as part of the application protection enforcement. In such an embodiments, steps 404 and 406 may further include defining (in the application protection registration tool) additional policies to track runtime metrics followed by the execution, in a runtime environment, instrumented executables of the first application to generate the runtime metrics (where instrumentation is embed into the instrumented executables by the cloud protection toolchain according to the additional policies). In addition, as part of step 410, an instrumentation cloud tool, executing in the cloud computing environment, may gather the runtime metrics from the runtime environment. Thereafter, step 410 may include the generation, in an audit reporting tool executing in the cloud computing environment, a security report that tracks the runtime metrics and identifies variances from the collected protection policy settings and the transmission of the security report for further processing. The runtime may be selected from a group consisting of data on/relating to tampering attempts, debugging attempts, dynamic code signing failures, and custom runtime events. Also, in the runtime metrics based implementation, step 410 may include an alerting tool, executing in the cloud computing environment, generating a real-time alert notification based on the runtime metrics exceeding a predefined threshold as defined in the collected protection policy settings.

### Hardware Environment

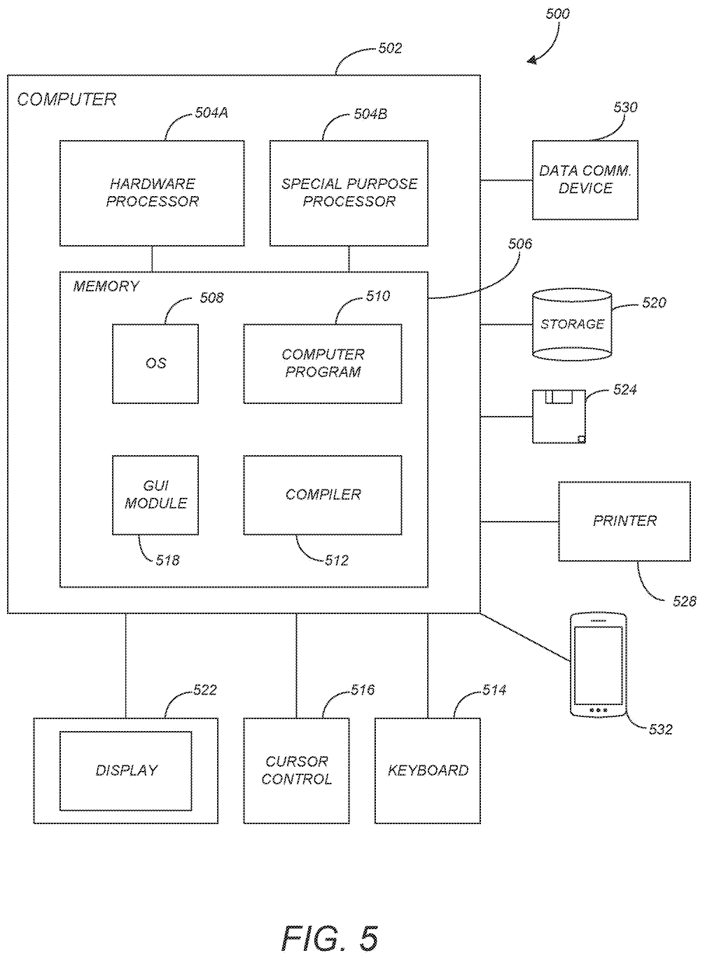

FIG. 5 is an exemplary hardware and software environment 500 (referred to as a computer-implemented system and/or computer-implemented method) used to implement one or more embodiments of the invention. The hardware and software environment includes a computer 502 and may include peripherals. Computer 502 may be a user/client computer, server computer, or may be a database computer. The computer 502 comprises a hardware processor 504A and/or a special purpose hardware processor 504B (hereinafter alternatively collectively referred to as processor 504) and a memory 506, such as random access memory (RAM). The computer 502 may be coupled to, and/or integrated with, other devices, including input/output (I/O) devices such as a keyboard 514, a cursor control device 516 (e.g., a mouse, a pointing device, pen and tablet, touch screen, multi-touch device, etc.) and a printer 528. In one or more embodiments, computer 502 may be coupled to, or may comprise, a portable or media viewing/listening device 532 (e.g., an MP3 player, IPOD, NOOK, portable digital video player, cellular device, personal digital assistant, etc.). In yet another embodiment, the computer 502 may comprise a multi-touch device, mobile phone, gaming system, internet enabled television, television set top box, or other internet enabled device executing on various platforms and operating systems.

In one embodiment, the computer 502 operates by the hardware processor 504A performing instructions defined by the computer program 510 (e.g., a computer-aided design [CAD] application) under control of an operating system 508. The computer program 510 and/or the operating system 508 may be stored in the memory 506 and may interface with the user and/or other devices to accept input and commands and, based on such input and commands and the instructions defined by the computer program 510 and operating system 508, to provide output and results.

Output/results may be presented on the display 522 or provided to another device for presentation or further processing or action. In one embodiment, the display 522 comprises a liquid crystal display (LCD) having a plurality of separately addressable liquid crystals. Alternatively, the display 522 may comprise a light emitting diode (LED) display having clusters of red, green and blue diodes driven together to form full-color pixels. Each liquid crystal or pixel of the display 522 changes to an opaque or translucent state to form a part of the image on the display in response to the data or information generated by the processor 504 from the application of the instructions of the computer program 510 and/or operating system 508 to the input and commands. The image may be provided through a graphical user interface (GUI) module 518. Although the GUI module 518 is depicted as a separate module, the instructions performing the GUI functions can be resident or distributed in the operating system 508, the computer program 510, or implemented with special purpose memory and processors.

In one or more embodiments, the display 522 is integrated with/into the computer 502 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 502 according to the computer program 510 instructions may be implemented in a special purpose processor 504B. In this embodiment, some or all of the computer program 510 instructions may be implemented via firmware instructions stored in a read only memory (ROM), a programmable read only memory (PROM) or flash memory within the special purpose processor 504B or in memory 506. The special purpose processor 504B may also be hardwired through circuit design to perform some or all of the operations to implement the present invention. Further, the special purpose processor 504B may be a hybrid processor, which includes dedicated circuitry for performing a subset of functions, and other circuits for performing more general functions such as responding to computer program 510 instructions. In one embodiment, the special purpose processor 504B is an application specific integrated circuit (ASIC).

The computer 502 may also implement a compiler 512 that allows an application or computer program 510 written in a programming language such as C, C++, Assembly, SQL, PYTHON, PROLOG, MATLAB, RUBY, RAILS, HASKELL, or other language to be translated into processor 504 readable code. Alternatively, the compiler 512 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 510 accesses and manipulates data accepted from I/O devices and stored in the memory 506 of the computer 502 using the relationships and logic that were generated using the compiler 512.

The computer 502 also optionally comprises an external communication device such as a modem, satellite link, Ethernet card, or other device for accepting input from, and providing output to, other computers 502.

In one embodiment, instructions implementing the operating system 508, the computer program 510, and the compiler 512 are tangibly embodied in a non-transitory computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of computer program 510 instructions which, when accessed, read and executed by the computer 502, cause the computer 502 to perform the steps necessary to implement and/or use the present invention or to load the program of instructions into a memory 506, thus creating a special purpose data structure causing the computer 502 to operate as a specially programmed computer executing the method steps described herein. Computer program 510 and/or operating instructions may also be tangibly embodied in memory 506 and/or data communications devices 530, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 502.

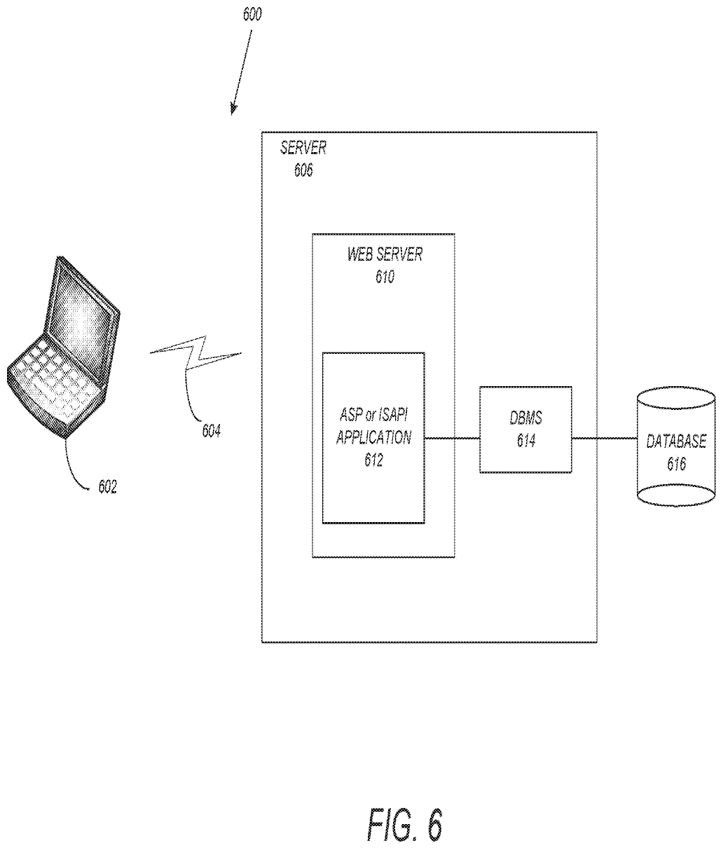

FIG. 6 schematically illustrates a typical distributed/cloud-based computer system 600 using a network 604 to connect client computers 602 to server computers 606. A typical combination of resources may include a network 604 comprising the Internet, LANs (local area networks), WANs (wide area networks), SNA (systems network architecture) networks, or the like, clients 602 that are personal computers or workstations (as set forth in FIG. 5), and servers 606 that are personal computers, workstations, minicomputers, or mainframes (as set forth in FIG. 5). However, it may be noted that different networks such as a cellular network (e.g., GSM [global system for mobile communications] or otherwise), a satellite based network, or any other type of network may be used to connect clients 602 and servers 606 in accordance with embodiments of the invention.

A network 604 such as the Internet connects clients 602 to server computers 606. Network 604 may utilize ethernet, coaxial cable, wireless communications, radio frequency (RF), etc. to connect and provide the communication between clients 602 and servers 606. Further, in a cloud-based computing system, resources (e.g., storage, processors, applications, memory, infrastructure, etc.) in clients 602 and server computers 606 may be shared by clients 602, server computers 606, and users across one or more networks. Resources may be shared by multiple users and can be dynamically reallocated per demand. In this regard, cloud computing may be referred to as a model for enabling access to a shared pool of configurable computing resources. In addition, as describe above, the cloud-based computing system/environment may consist of a secure cloud computing environment such that particular services (e.g., the dynamic code signing) cannot be carried out without cloud credentials or with insufficient permissions. A correctly defined permissions structure ensures that only parties with the appropriate credentials can request dynamic signing for production deployment and that signing will only be permitted for applications build with valid developer credentials.

Clients 602 may execute a client application or web browser and communicate with server computers 606 executing web servers 610. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 602 may be downloaded from server computer 606 to client computers 602 and installed as a plug-in or ACTIVEX control of a web browser. Accordingly, clients 602 may utilize ACTIVEX components/component object model (COM) or distributed COM (DCOM) components to provide a user interface on a display of client 602. The web server 610 is typically a program such as MICROSOFT'S INTERNET INFORMATION SERVER.

Web server 610 may host an Active Server Page (ASP) or Internet Server Application Programming Interface (ISAPI) application 612, which may be executing scripts. The scripts invoke objects that execute business logic (referred to as business objects). The business objects then manipulate data in database 616 through a database management system (DBMS) 614. Alternatively, database 616 may be part of, or connected directly to, client 602 instead of communicating/obtaining the information from database 616 across network 604. When a developer encapsulates the business functionality into objects, the system may be referred to as a component object model (COM) system. Accordingly, the scripts executing on web server 610 (and/or application 612) invoke COM objects that implement the business logic. Further, server 606 may utilize MICROSOFT'S TRANSACTION SERVER (MTS) to access required data stored in database 616 via an interface such as ADO (Active Data Objects), OLE DB (Object Linking and Embedding DataBase), or ODBC (Open DataBase Connectivity).

Generally, these components 600-616 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 602 and 606 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 602 and 606. Embodiments of the invention are implemented as a software/CAD application on a client 602 or server computer 606. Further, as described above, the client 602 or server computer 606 may comprise a thin client device or a portable device that has a multi-touch-based display.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of enforcing application protection in the cloud, comprising:
receiving, in an application protection registration tool executing within a cloud computing environment, a request to register a first application for protection;
collecting, in the application protection registration tool, application information data and protection policy settings for the first application;
registering, via the application protection registration tool, the first application by returning, to a build-time environment, a secure protection authorization (SPA) certificate that authorizes the first application to be built according to the collected protection policy settings, and wherein the SPA includes first developer credentials;
receiving, in a build registration tool executing in the cloud computing environment, from a cloud protection toolchain executing in the build-time environment, signed build-data, wherein the signed build data comprises the SPA and build information for a build of the first application;
determining, in the cloud computing environment, that the SPA is authenticate, the first developer credentials are authorized, and the build information is valid; and
based on the determining, the build registration tool responding to the cloud protection toolchain that the build for the first application is authorized.

2. The method of claim 1, wherein the request to register the first application is received via a web interface to the application protection registration tool.

3. The method of claim 1, further comprising:
collecting, in the application protection registration tool second developer credentials;
determining, in the application protection registration tool, that the second developer credentials are not consistent with the developer permissions and are therefore not authorized; and
based on the unauthorized developer credentials, failing the registration of the first application.

4. The method of claim 1, further comprising:
the build registration tool generating audit data for the build; and
wherein the build registration tool further determines that the first application is authorized based on compliance of the audit data with the collected protection policy settings.

5. The method of claim 4, further comprising:
an audit reporting tool, executing in the cloud computing environment, generating a security report based on the audit data, wherein the security report identifies variances from the collected protection policy settings.

6. The method of claim 1, further comprising:
an alerting tool, executing in the cloud computing environment, generating a real-time alert in accordance with the collected protection policy settings.

7. The method of claim 1, further comprising:
defining, in the application protection registration tool, additional protection policies to track runtime metrics;
executing, in a runtime environment, instrumented executables of the first application to generate the runtime metrics, wherein instrumentation is embed into the instrumented executables by the cloud protection toolchain according to the additional protection policies;
an instrumentation cloud tool, executing in the cloud computing environment, gathering the runtime metrics from the runtime environment;
generating, in an audit reporting tool executing in the cloud computing environment, a security report that tracks the runtime metrics and identifies variances from the collected protection policy settings; and
transmitting the security report for further processing.

8. The method of claim 7, wherein the runtime metrics is selected from a group consisting of data on tampering attempts, debugging attempts, dynamic code signing failures, and custom runtime events.

9. The method of claim 7, further comprising:
an alerting tool, executing in the cloud computing environment, generating a real-time alert notification based on the runtime metrics exceeding a predefined threshold as defined in the collected protection policy settings.

10. A system for enforcing application protection in the cloud, comprising:
(a) a cloud computing environment having one or more computers;
(b) the one or more computers, wherein each of the one or more computers has a memory and a processor that executes;
(c) an application protection registration tool executing on one or more of the processors via a set of instructions stored in one or more of the memories, wherein the application protection registration tool performs operations comprising:
(i) receiving a request to register a first application for protection;
(ii) collecting application information data and protection policy settings for the first application;
(iii) registering the first application by returning, to a build-time environment, a secure protection authorization (SPA) certificate that authorizes the first application to be built according to the collected protection policy settings, and wherein the SPA includes first developer credentials; and
(d) a build registration tool executing on one or more of the processors via the set of instructions stored in one or more of the memories, wherein the build registration tool performs operations comprising:
(i) receiving from a cloud protection toolchain executing in the build-time environment, signed build-data, wherein the signed build data comprises the SPA and build information for a build of the first application;
(ii) determining that the SPA is authenticate, the first developer credentials are authorized, and the build information is valid; and
(iii) based on the determining, the build registration tool responding to the cloud protection toolchain that the build for the first application is authorized.

11. The system of claim 10, wherein the application protection registration tool receives the request to register the first application via a web interface.

12. The system of claim 10, wherein the application protection registration tool operations further comprise:
collecting second developer credentials;
determining that the second developer credentials are not consistent with the developer permissions and are therefore not authorized; and
based on the unauthorized developer credentials, failing the registration of the first application.

13. The system of claim 10, wherein the build registration tool operations further comprise:
generating audit data for the build; and
determining that the first application is authorized based on compliance of the audit data with the collected protection policy settings.

14. The system of claim 13, further comprising:
an audit reporting tool executing on one or more of the processors via the set of instructions stored in one or more of the memories, wherein the audit reporting tool performs operations comprising:
generating a security report based on the audit data, wherein the security report identifies variances from the collected protection policy settings.

15. The system of claim 10, further comprising:
an alerting tool executing on one or more of the processors via the set of instructions stored in one or more of the memories, wherein the alerting tool performs operations comprising:
generating a real-time alert in accordance with the collected protection policy settings.

16. The system of claim 10, wherein:
the application protection registration tool operations further comprise:
defining additional policies to track runtime metrics;
a runtime environment executing on one or more of the processors via the set of instructions stored in one or more of the memories, wherein the runtime environment performs operations comprising:
executing instrumented executables of the first application to generate the runtime metrics, wherein instrumentation is embed into the instrumented executables by the cloud protection toolchain according to the additional policies;
an instrumentation cloud tool executing on one or more of the processors via the set of instructions stored in one or more of the memories, wherein the instrumentation cloud tool performs operations comprising:
gathering the runtime metrics from the runtime environment; and
an audit reporting tool executing on one or more of the processors via the set of instructions stored in one or more of the memories, wherein the audit reporting tool performs operations comprising:
generating a security report that tracks the runtime metrics and identifies variances from the collected protection policy settings; and
transmitting the security report for further processing.

17. The system of claim 16, wherein the runtime metrics is selected from a group consisting of data on tampering attempts, debugging attempts, dynamic code signing failures, and custom runtime events.

18. The system of claim 16, further comprising:
an alerting tool executing on one or more of the processors via the set of instructions stored in one or more of the memories, wherein the alerting tool performs operations comprising:
generating a real-time alert notification based on the runtime metrics exceeding a predefined threshold as defined in the collected protection policy settings.
